(19) United States
(12) Patent Application Publication
(10) Pub. No.: US 2012/0247860 A1
(43) Pub. Date: Oct. 4, 2012

(54) TRACTORS

(75) Inventors: Martin Brenninger, Marktoberdorf (DE); Oliver Kreil, Kaltental (DE); Hans-Peter Zeiler, Marktoberdorf (DE)

(73) Assignee: AGCO GMBH, Marktoberdorf (DE)

(21) Appl. No.: 13/394,196

(22) PCT Filed: Sep. 6, 2010
(86) PCT No.: PCT/IB2010/002205

§ 371 Date: Jun. 19, 2012

(30) Foreign Application Priority Data
Sep. 4, 2009 (GB) 0915402.2

(51) Int. Cl. B60W 30/00; B60W 10/10; B60W 10/18; B60T 8/32

(52) U.S. Cl. 180/282

(57) ABSTRACT

A vehicle has an engine (10) which drives wheels (16,24) of the vehicle via a CVT (11). The vehicle also has a driver operated braking system which brakes wheels of the vehicle, and an electronic control system (28,60) which, in the event of deceleration of the vehicle, detects when the driven wheels are about to lock and increases the currently operative CVT ratio to allow the locking wheels to speed up towards a rotational speed corresponding with the current vehicle speed whilst ensuring that any braking operation selected by the driver is maintained subject to the avoidance of wheel locking. The CVT is of the hydrostatic/mechanical power split type and the braking system includes an anti-lock braking (ABS) function which can provide the wheel speed and vehicle speed values and prevent wheel locking under braking.

This invention relates to tractors and in particular with tractors having continuously variable transmissions (CVTs) that is transmissions in which the operative ratio of the transmission can be varied continuously.

Problems arise with tractors having CVTs when the tractor decelerates either due to a throttle pedal being released, a hand control lever being moved to decelerate the vehicle, the gear ratio being changed by the driver or the brake pedal being applied.

During such deceleration the ratio of the CVT is automatically reduced by a CVT control system to provide engine braking and this can lead to the speed of the driven wheels reducing considerably and, particularly when the vehicle is travelling over low friction surfaces, approaching a situation where the driven wheels are locked or about to lock even if the brakes are not applied. This is a very unstable situation and is best avoided.

Also if the brakes have been applied and are released it may not be possible for the now unbraked wheels to speed up due to the low currently operative CVT ratio.

It is an object of the present invention to provide a vehicle with a CVT which at least mitigates the above problems.

Thus in accordance with the present invention there is provided a vehicle having an engine which drives wheels of the vehicle via a CVT, a driver operated braking system which brakes wheels of the vehicle, and an electronic control system which, in the event of deceleration of the vehicle, detects when the driven wheels are about to lock and increases the currently operative CVT ratio to allow the locking wheels to speed up towards a rotational speed corresponding with the current vehicle speed whilst ensuring that any braking operation selected by the driver is maintained subject to the avoidance of wheel locking.

Such a vehicle avoids wheel locking during deceleration whether the brakes are applied or released.

The electronic control system may, for example, measure the vehicle speed and the speed of rotation, of the driven wheels and then calculate if the speed of rotation of the wheels is lower than that required to give the vehicle speed, thus indicating an imminent locking of the wheels.

In a preferred arrangement the CVT is of the hydrostatic/mechanical power split type.

Conveniently the braking system includes an anti-lock braking system (ABS) function which can provide the wheel speed and vehicle speed values and prevent wheel locking under braking.

The invention also provides a vehicle which has an engine which drives wheels of the vehicle via a hydrostatic/mechanical power split CVT, the vehicle also including a braking system which has an ABS function to control wheel locking under braking.

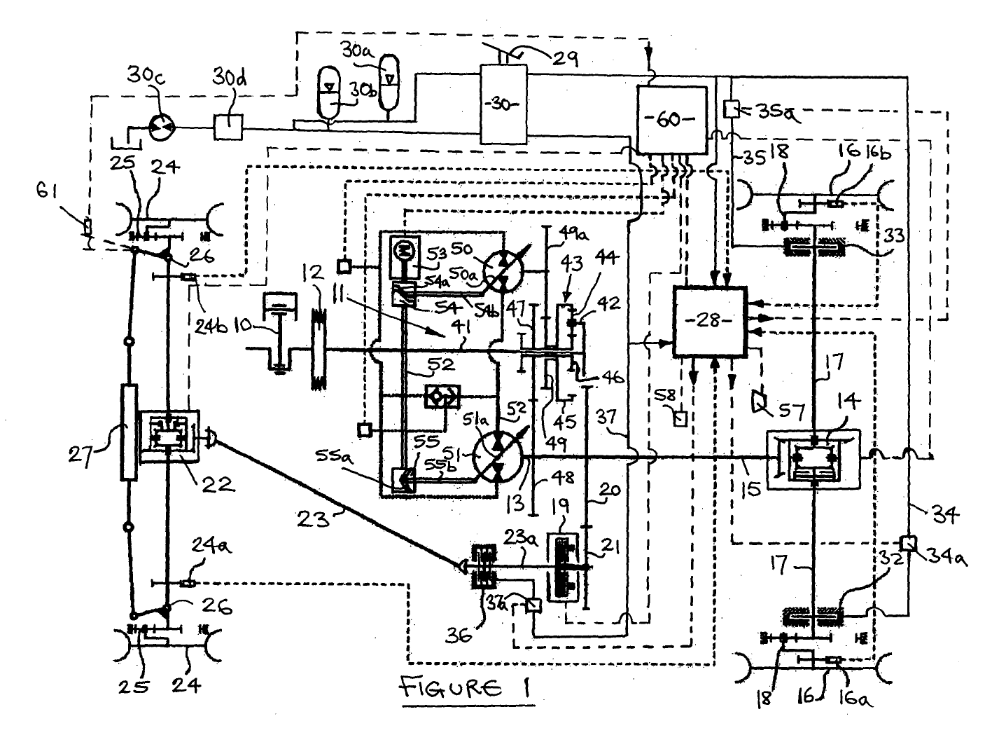

One embodiment of the present invention will now be described, by way of example only, with reference to the accompanying FIG. 1 which shows diagrammatically the braking, drive and control systems for a four wheel drive tractor in accordance with the present invention.

Referring to FIG. 1, an engine 10 drives a CVT 11 via a flywheel 12. CVT output shaft 13 drives a rear axle differential 14 via a shaft 15 and rear wheels 16 via half shafts 17 and final reduction gears 18. Output shaft 13 also drives front wheel drive clutch 19 via meshing gears 20,21 which in turn drives a front axle differential 22 via shafts 23 and 23a. Differential 22 drives front wheels 24 via final reduction gears 25. Wheels 24 are steerable about substantially vertical axes 26 using a hydraulic steering cylinder 27 mounted on the front axle casing.

The tractor has a braking system actuated by a pedal 29 which operates a brake control valve 30 which is supplied with pressurised hydraulic fluid by accumulators 30a and 30b which are charged by a pump 30c via a shut-off valve 30d which ensures the filling of accumulators 30a and 30b. Left and right rear brakes 32 and 33 are operated via lines 34 and 35 from valve 30 and a front brake 36 provided on shaft 23a is operated via line 37.

The braking system is controlled by an electronic control unit 28 which includes an ABS function to prevent the locking of the wheels under braking. Control unit 28 receives vehicle operating parameter signals such as the brake pressure in lines 34,35 and 37, the wheel speeds from sensors 16a, 16b and 24a, 24b and optionally vehicle speed from a radar unit 57 [symbol] vehicle acceleration from a sensor 58. The control unit 28 operates pressure control valves 34a, 35a and 37a in brake lines 34,35 and 37 respectively to prevent the brake pressure rising to levels at which wheel locking will occur in the normal ABS manner.

The CVT 11 has an input shaft 41 driven from engine 10 which drives the planet carrier 42 of epicyclic gear 43. Planet gears 44 of epicyclic 43 drive an annulus gear 45 and a sun gear 46.

Sun gear 46 drives gear 47 which meshes with gear 48 on output shaft 13. Annulus gear 45 drives gear 49 which in turn drive a variable displacement hydraulic pump 50 via gear 49a. Pump 50 drives variable displacement hydraulic motor 51 via piping 52. Motor 51 in turn also drives CVT output shaft 13.

CVT 11 is thus of the hydro-mechanical power-split type and operates briefly as follows. Pump 50 and motor 51 are both of the variable angle swash-plate type in which the angle of the swash-plates shown diagrammatically at 50a and 51a determines the delivery/intake volume of the pump/motor. The angle of the swash-plates 50a and 51a is controlled by shaft 52 which is rotated by an actuating motor 53. Shaft 52 carries cam cylinders 54 and 55 which have peripheral cam tracks 54a and 55a in which followers on the ends of actuating 54b and 55b engage. Rods 54b and 55b respectively operate swash-plates 50a and 51a respectively (via valves and actuating pistons not shown in FIG. 1 to vary the power transmitted from pump 50 to motor 51.

A tractor control system 60 is provided which controls the operative ratio of the CVT either automatically in response to the load or other factors imposed on the tractor and/or in response to operating conditions set by the tractor driver.

This control system 60 is connected with brake control unit 28 and also controls the operation of the front and rear differentials 22 and 14 as well as other tractor functions not described herein and receives front wheel turn angle signals from sensor 61.

In accordance with the present invention, the brake control unit 28 continuously monitors the speed of rotation of the wheels 16 and 24 of the vehicle to detect when a particular wheel is about to lock. This is done by comparing the current speed of rotation of each wheel from the sensors 16a and 24a with the current speed of the vehicle which can be taken from an acceleration sensor (more common when an ABS function is fitted), radar unit 57 (if filled) or can be calculated from engine speed and gear ratio.

Thus if the vehicle decelerates, either due to the driver releasing the engine throttle pedal, a hand control lever being moved to decelerate the vehicle, the gear ratio being changed by the driver or the driver applying the brakes, the control system 60 adjusts the operative ratio of the CVT to provide engine braking. The brake control unit 28 monitors wheel speed and brake pressure to provide the ABS function. If control unit 28 detects any tendency for the wheels 16 and 24 to lock this brake pressure is reduced accordingly by operating pressure control valves 34a, 35a and 37a and the locking condition is communicated to the control system 60 which then raises the currently operative CVT ratio to allow the wheels which were locking to speed up to a wheel speed appropriate for the current speed of the vehicle.

In the example described, there is one pump 50 which drives a single motor 51 which drives both front and rear wheels 24 and 16. The present invention is also applicable to CVTs in which a single pump drives two motors one of which drives the front wheels and the other of which drives the rear wheels. This enables the ratio applied to each wheel axle to be controlled separately

1. A vehicle having an engine which drives wheels of the vehicle via a CVT, a driver operated braking system which brakes wheels of the vehicle, and an electronic control system which, in the event of deceleration of the vehicle, detects when the driven wheels are about to lock and increases the currently operative CVT ratio to allow the locking wheels to speed up towards a rotational speed corresponding with the current vehicle speed whilst ensuring that any braking operation selected by the driver is maintained subject to the avoidance of wheel locking wherein the CVT is of the hydrostatic/mechanical power split type, the hydrostatic portion on the CVT has a single hydraulic pump which drives two hydraulic motors one motor driving front wheels of the vehicle and the other motor driving rear wheels of the vehicle so that wheel locking of the front and rear wheels can be controlled separately

2. A vehicle according to claim 1 in which the electronic control system measures the vehicle speed and the speed of rotation of the driven wheels of the vehicle and then calculate if the speed of rotation of the wheels is lower than that required to give the vehicle speed, thus indicating an imminent locking of the wheels.

3. (canceled)

4. (canceled)

5. (canceled)

6. (canceled)

7. (canceled)

8. A vehicle according to claim 2 in which the braking system includes an anti-lock braking system (ABS) function which can provide the wheel speed and vehicle speed values and prevent wheel locking under braking.
